(19) United States
(12) Patent Application Publication
(10) Pub. No.: US 2013/0108907 A1
(43) Pub. Date: May 2, 2013

(54) CURVED BATTERY CELLS FOR PORTABLE ELECTRONIC DEVICES

(71) Applicants: Ramesh C. Bhardwaj, Fremont, CA (US); John Raff, Menlo Park, CA (US); Stephen R. McClure, San Francisco, CA (US); Erik L. Wang, Redwood City, CA (US); Taisup Hwang, Santa Clara, CA (US)

(72) Inventors: Ramesh C. Bhardwaj, Fremont, CA (US); John Raff, Menlo Park, CA (US); Stephen R. McClure, San Francisco, CA (US); Erik L. Wang, Redwood City, CA (US); Taisup Hwang, Santa Clara, CA (US)

(73) Assignee: APPLE INC., Cupertino, CA (US)

(21) Appl. No.: 13/283,750

(22) Filed: Oct. 28, 2011

(51) Int. Cl. H01M 2/02; H02J 7/00; H01M 10/36; H01M 10/04; H01M 10/0587

(52) U.S. Cl. 429/94; 29/623.2; 29/623.4; 29/623.1; 429/163; 320/137

(57) ABSTRACT

The disclosed embodiments relate to the manufacture of a battery cell. The battery cell includes a set of layers including a cathode with an active coating, a separator, and an anode with an active coating. The battery cell also includes a pouch enclosing the layers, wherein the pouch is flexible. The layers may be wound to create a jelly roll prior to sealing the layers in the flexible pouch. A curve may also be formed in the battery cell by applying a pressure of at least 0.13 kilogram-force (kgf) per square millimeter to the layers using a set of curved plates applying a temperature of about 85° C. to the layers.

### BACKGROUND

1. Field

The present embodiments relate to batteries for portable electronic devices. More specifically, the present embodiments relate to the manufacture of curved battery cells to facilitate efficient use of space within portable electronic devices.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

However, efficient use of space may be limited by the use and arrangement of cells in existing battery pack architectures. In particular, battery packs typically contain rectangular cells of the same capacity, size, and dimensions. The physical arrangement of the cells may additionally mirror the electrical configuration of the cells. For example, a six-cell battery pack may include six lithium-polymer cells of the same size and capacity configured in a two in series, three in parallel (2s3p) configuration. Within such a battery pack, two rows of three cells placed side-by-side may be stacked on top of each other; each row may be electrically coupled in a parallel configuration and the two rows electrically coupled in a series configuration. Consequently, the battery pack may require space in a portable electronic device that is at least the length of each cell, twice the thickness of each cell, and three times the width of each cell.

Moreover, this common type of battery pack design may be unable to utilize free space in the portable electronic device that is outside of a rectangular space reserved for the battery pack. For example, a rectangular battery pack of this type may be unable to efficiently utilize free space that is curved, rounded, and/or irregularly shaped.

Hence, the use of portable electronic devices may be facilitated by improvements related to the packaging efficiency, capacity, form factor, design, and/or manufacturing of battery packs containing lithium-polymer battery cells.

### SUMMARY

The disclosed embodiments relate to the manufacture of a battery cell. The battery cell includes a set of layers including a cathode with an active coating, a separator, and an anode with an active coating. The battery cell also includes a pouch enclosing the layers, wherein the pouch is flexible. The layers may be wound to create a jelly roll prior to sealing the layers in the flexible pouch. A curve may also be formed in the battery cell by applying a pressure of at least 0.13 kilogram-force (kgf) per square millimeter to the layers using a set of curved plates and/or applying a temperature of about 85° C. to the layers.

In some embodiments, the pressure and the temperature are applied to the layers for about four hours.

In some embodiments, the layers also include a binder coating that laminates the layers together upon applying the pressure and the temperature to the layers. For example, the combination of pressure, temperature, and time may melt the binder coating and laminate the cathode, anode, and separator layers together, thus forming a solid structure that maintains the curve outlined by the curved plates after the curved plates have been removed from either side of the battery cell.

In some embodiments, the curve is formed to facilitate efficient use of space inside a portable electronic device. For example, the curve may be formed at one or more ends of the battery cell to allow the battery cell to occupy a curved and/or rounded space within the enclosure of a laptop computer, tablet computer, mobile phone, personal digital assistant (PDA), digital camera, portable media player, and/or other type of battery-powered electronic device.

### BRIEF DESCRIPTION OF THE FIGURES

FIG. 1 shows a top-down view of a battery cell in accordance with an embodiment.

FIG. 2 shows a cross-sectional view of a battery cell in accordance with an embodiment.

FIG. 3 shows a cross-sectional view of the placement of a battery cell within an enclosure for a portable electronic device in accordance with an embodiment.

FIG. 4 shows the degassing of a battery cell in accordance with an embodiment.

FIG. 5 shows a flowchart illustrating the process of manufacturing a battery cell in accordance with an embodiment.

FIG. 6 shows a portable electronic device in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure.

Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments related to the manufacture of a battery cell. The battery cell may contain a set of layers, including a cathode with an active coating, a separator, an anode with an active coating, and/or a binder coating. The layers may be wound to form a jelly roll and sealed into a flexible pouch to form the battery cell.

In addition, a curve may be formed in the battery cell by applying a pressure of at least 0.13 kilogram-force (kgf) per square millimeter to the layers using a set of curved plates. To further form the curve, a temperature of about 85° C. may also be applied to the layers (e.g., using a heater or other source of heat). For example, the application of pressure and temperature to the layers for four hours may melt the binder coating and laminate the layers together, thus creating a solid structure that maintains the curve outlined by the curved plates after the curved plates have been removed from either side of the battery cell. The curve may additionally facilitate efficient use of space within the portable electronic device by, for example, accommodating a curved and/or rounded shape of the portable electronic device.

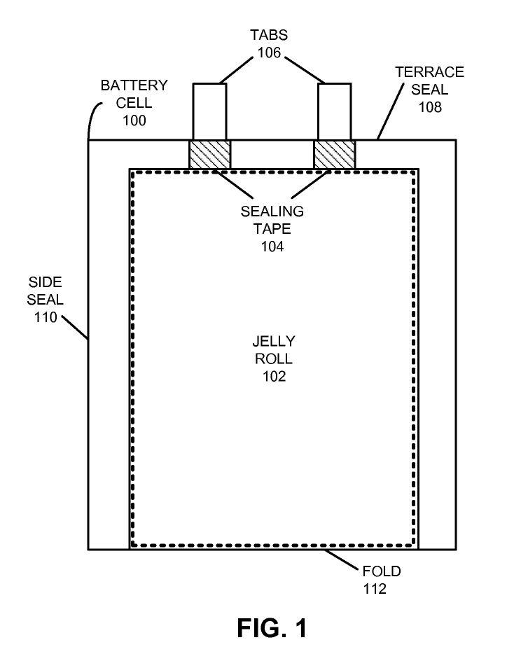

FIG. 1 shows a top-down view of a battery cell 100 in accordance with an embodiment. Battery cell 100 may correspond to a lithium-polymer cell that is used to power a portable electronic device. Battery cell 100 includes a jelly roll 102 containing a number of layers which are wound together, including a cathode with an active coating, a separator, and an anode with an active coating. More specifically, jelly roll 102 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Jelly rolls are well known in the art and will not be described further.

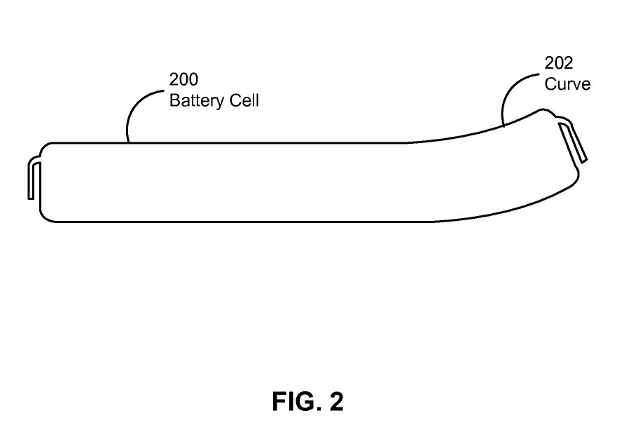

Jelly roll 102 may also include a binder coating between the cathode and separator and/or separator and anode layers. The binder coating may include polyvinylidene fluoride (PVDF) and/or another binder material. In addition, the binder coating may be applied as a continuous and/or non-continuous coating to the separator, cathode, and/or anode. For example, the binder coating may be applied as a continuous coating on the separator using a dip-coating technique. Alternatively, the binder coating may be applied as a non-continuous coating on the surface of the cathode and/or anode facing the separator using a spray-coating technique. As discussed in further detail below with respect to FIG. 2, the binder coating may be used to laminate and/or bond the layers together and form a curve in battery cell 100.

During assembly of battery cell 100, jelly roll 102 is enclosed in a flexible pouch, which is formed by folding a flexible sheet along a fold line 112. For example, the flexible sheet may be made of aluminum with a polymer film, such as polypropylene. After the flexible sheet is folded, the flexible sheet can be sealed, for example by applying heat along a side seal 110 and along a terrace seal 108.

Jelly roll 102 also includes a set of conductive tabs 106 coupled to the cathode and the anode. Conductive tabs 106 may extend through seals in the pouch (for example, formed using sealing tape 104) to provide terminals for battery cell 100. Conductive tabs 106 may then be used to electrically couple battery cell 100 with one or more other battery cells to form a battery pack. For example, the battery pack may be formed by coupling the battery cells in a series, parallel, or series-and-parallel configuration. The coupled cells may be enclosed in a hard case to complete the battery pack, or the coupled cells may be embedded within the enclosure of a portable electronic device, such as a laptop computer, tablet computer, mobile phone, personal digital assistant (PDA), digital camera, and/or portable media player.

FIG. 2 shows a cross-sectional view of a battery cell 200 in accordance with an embodiment. As with battery cell 100 of FIG. 1, battery cell 200 may include a number of layers enclosed in a flexible pouch. The layers may include a cathode with active coating, a separator, an anode with active coating, and/or a binder coating. The layers may be wound to create a jelly roll for the battery cell, such as jelly roll 102 of FIG. 1. Alternatively, the layers may be used to form other types of battery cell structures, such as bi-cell structures.

As shown in FIG. 2, battery cell 200 may include a curve 202. Curve 202 may correspond to a gentle bend in one or more dimensions of battery cell 200. To form curve 202, a pressure of at least 0.13 kilogram-force (kgf) per square millimeter may be applied to the layers using a set of curved plates that exhibit the same upward bend as curve 202. A temperature of about 85° C. may also be applied to the layers using a heater and/or other source of heat. For example, to create curve 202 in a battery cell for a tablet computer, the layers may be clamped between a set of curved steel plates at a pressure of 900 kgf and baked at a temperature of 85° C. for four hours. The application of pressure, temperature, and/or time to the layers may melt the binder coating and laminate (e.g., bond) the layers together, creating a solid, compressed structure that maintains the curve (e.g., curve 202) outlined by the curved plates after the curved plates have been removed from either side of the battery cell.

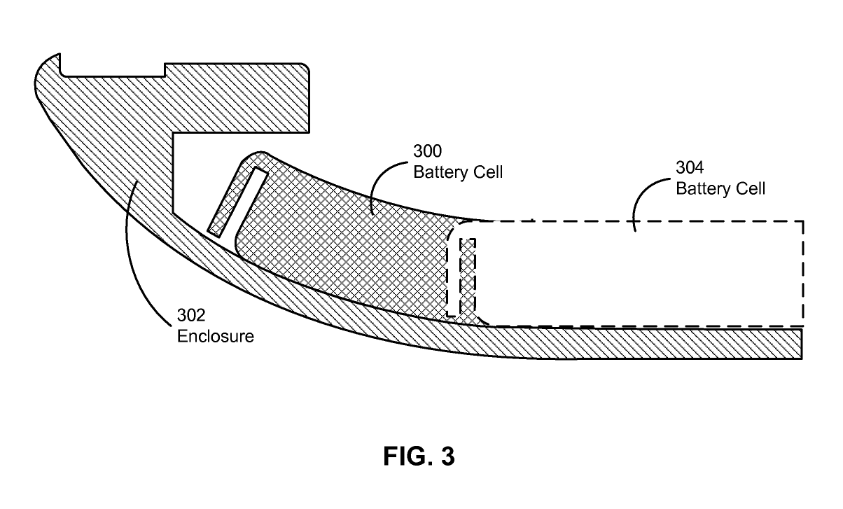

In turn, the formation of curve 202 may facilitate efficient use of space within a portable electronic device. For example, curve 202 may be formed at one or more ends of battery cell 200 to allow battery cell 200 to fit within a curved and/or rounded enclosure for the portable electronic device, as discussed in further detail below with respect to FIG. 3. In other words, battery cell 200 may include an asymmetric and/or non-rectangular design that accommodates the shape of the portable electronic device. In turn, battery cell 200 may provide greater capacity, packaging efficiency, and/or voltage than rectangular battery cells in the same portable electronic device.

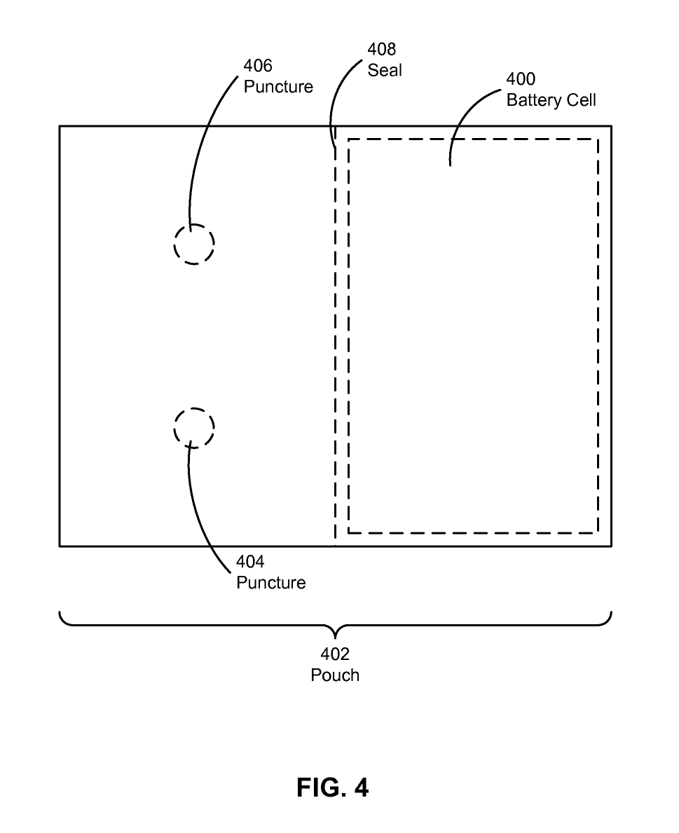

Prior to applying the pressure and the temperature to the layers, a formation charge may be performed on battery cell 200. The formation charge may electrochemically form battery cell 200 by leaving a voltage and polarity imprint on the layers. However, the formation charge may generate gas that accumulates within the pouch. As a result, battery cell 200 may be degassed after the pressure and temperature are applied to the layers to release the gas and prepare battery cell 200 for installation in a portable electronic device, as discussed in further detail below with respect to FIG. 4.

FIG. 3 shows a cross-sectional view of the placement of a battery cell 300 within an enclosure 302 for a portable electronic device in accordance with an embodiment. As shown in FIG. 3, enclosure 302 may include a curved and/or rounded outline, within which a flat (e.g., rectangular) battery cell 304 may not fit. Instead, battery cell 304 may be placed along a flat portion of enclosure 302, and the curved space within enclosure 302 may not be utilized.

Conversely, a curve may be formed at the end of battery cell 300 to facilitate placement of battery cell 300 within the curved portion of enclosure 302. For example, the curve may allow the end of battery cell 300 to be placed near a rounded edge of enclosure 302, thus facilitating the use of space within the portable electronic device.

The curve may additionally increase the size and/or capacity of battery cell 300 over that of a rectangular and/or flat battery cell (e.g., battery cell 304). For example, the formation of a curve in battery cell 300 may allow the width of battery cell 300 to be increased from 100 mm (e.g., for a rectangular/flat design) to 110 mm (e.g., for a curved design). The 10% increase in width may also provide a 10% increase in the capacity of battery cell 300, thus extending the runtime of the portable electronic device on a single charge.

FIG. 4 shows the degassing of a battery cell 400 in accordance with an embodiment. As shown in FIG. 4, battery cell 400 is enclosed in a pouch 402. In addition, pouch 402 contains extra material that does not contact the layers (e.g., cathode, anode, separator, binder coating) of battery cell 400.

To degas battery cell 400, a number of punctures 404-406 are made in the portion of the pouch not contacting the layers of battery cell 400 to release gas generated by battery cell 400 during a formation charge. Next, a new seal 408 is formed in pouch 402 along a line that is closer to the layers of battery cell 400 than punctures 404-406. In other words, seal 408 may be formed to hermetically reseal battery cell 400 in pouch 402 after punctures 404-406 have been made. Finally, extra pouch material associated with the punctured portion of pouch 402 (e.g., to the left of seal 408) is removed to complete the manufacturing of battery cell 400. Battery cell 400 may then be installed into a portable electronic device for use as a power source for the portable electronic device.

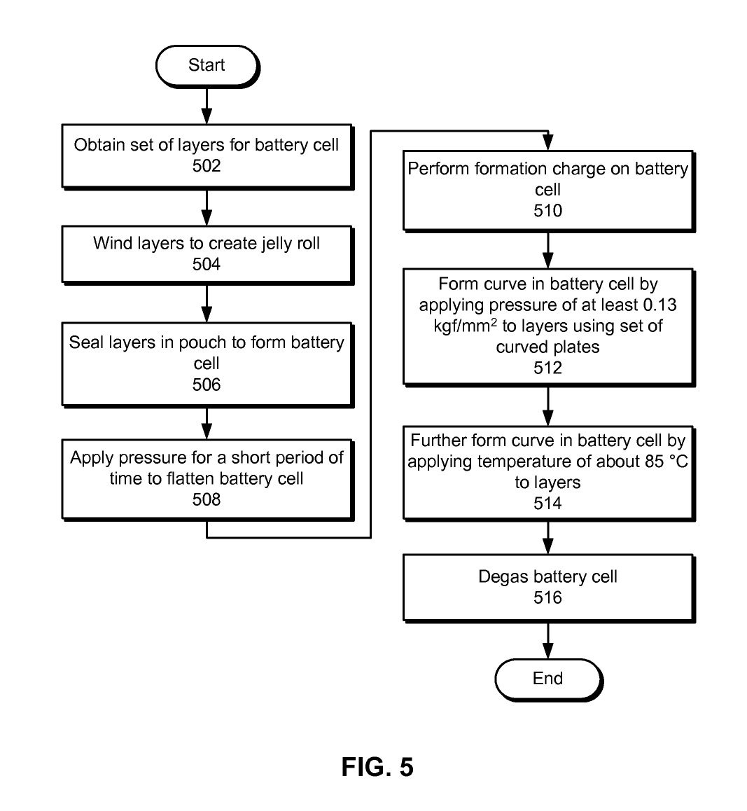

FIG. 5 shows a flowchart illustrating the process of manufacturing a battery cell in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

First, a set of layers for the battery cell is obtained (operation 502). The layers may include a cathode with an active coating, a separator, and an anode with an active coating. The layers may also include a binder coating applied to the cathode, anode, and/or separator.

Next, the layers are wound to create a jelly roll (operation 504). The winding step may be skipped and/or altered if the layers are used to create other battery cell structures, such as bi-cells. The layers are then sealed in a pouch to form the battery cell (operation 506). For example, the battery cell may be formed by placing the layers into the pouch, filling the pouch with electrolyte, and forming side and terrace seals along the edges of the pouch. The battery cell may then be left alone for 1-1.5 days to allow the electrolyte to distribute within the battery cell.

After the layers are sealed in the pouch, pressure is applied for a short period of time to flatten the battery cell (operation 508), and a formation charge is performed on the battery cell (operation 510). For example, the pressure may be applied for about a minute using a set of steel plates on either side of the battery cell. The formation charge may then be performed at one or more charge rates until the battery's voltage reaches a pre-specified amount.

A curve is then formed in the battery cell by applying a pressure of at least 0.13 kgf per square millimeter to the layers using a set of curved plates (operation 512). The curve may further be formed by applying a temperature of about 85° C. to the layers (operation 514) using a heater and/or other source of heat. In addition, the pressure and/or temperature may be applied to the layers for about four hours. Such application of pressure, temperature, and/or time may melt the binder coating and laminate the cathode, anode, and separator layers together, thus forming a solid structure that maintains the curve outlined by the curved plates after the curved plates have been removed from either side of the battery cell.

Finally, the battery cell is degassed (operation 516). To degas the battery cell, a portion of the pouch that does not contact the layers is punctured to release gas generated during the formation charge by the battery cell. Next, the pouch is resealed along a line that is closer to the layers than the punctured portion. Finally, extra pouch material associated with the punctured portion is removed from the battery cell.

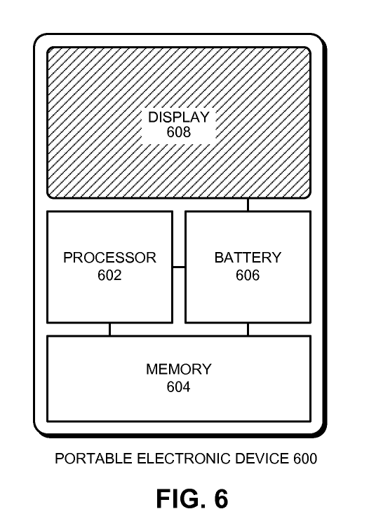

The above-described rechargeable battery cell can generally be used in any type of electronic device. For example, FIG. 6 illustrates a portable electronic device 600 which includes a processor 602, a memory 604 and a display 608, which are all powered by a battery 606. Portable electronic device 600 may correspond to a laptop computer, mobile phone, PDA, tablet computer, portable media player, digital camera, and/or other type of battery-powered electronic device. Battery 606 may correspond to a battery pack that includes one or more battery cells. Each battery cell may include a set of layers sealed in a pouch, including a cathode with an active coating, a separator, an anode with an active coating, and/or a binder coating. During manufacturing of the battery cell, a curve in the battery cell is formed by applying a pressure of at least 0.13 kgf per square millimeter to the layers using a set of curved plates. The curve may be further formed by applying a temperature of about 85° C. to the layers. In addition, the pressure and/or temperature may be applied to the layer for about four hours.

The pressure and/or temperature may bend the layers, melt the binder coating, and laminate the layers together, thus creating a solid structure that maintains the curve outlined by the curved plates after the curved plates have been removed from either side of the battery cell. The formation of the curve may also facilitate efficient use of space within portable electronic device 600. For example, the curve may be formed at one or more ends of the battery cell to allow the battery cell to occupy a curved and/or rounded space within the enclosure of portable electronic device 600.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for manufacturing a battery cell, comprising:
obtaining a set of layers for the battery cell, wherein the set of layers comprises a cathode with an active coating, a separator, and an anode with an active coating;
sealing the layers in a pouch to form the battery cell, wherein the pouch is flexible; and
forming a curve in the battery cell by applying a pressure of at least 0.13 kilogram-force (kgf) per square millimeter to the layers using a set of curved plates.

2. The method of claim 1, further comprising:
winding the layers to create a jelly roll prior to sealing the layers in the flexible pouch.

3. The method of claim 1, further comprising:
performing a formation charge on the battery cell; and
degassing the battery cell after the formation charge.

4. The method of claim 3, wherein degassing the battery cell involves:
puncturing a portion of the pouch that does not contact the layers to release gas generated during the formation charge by the battery cell;
resealing the pouch along a line that is closer to the layers than the punctured portion; and
removing extra pouch material associated with the punctured portion from the battery cell.

5. The method of claim 1, further comprising:
further forming the curve in the battery cell by applying a temperature of about 85° C. to the layers.

6. The method of claim 5, wherein the layers further comprise a binder coating that laminates the layers together upon applying the pressure and the temperature to the layers.

7. The method of claim 5, wherein the pressure and the temperature are applied to the layers for about four hours.

8. The method of claim 1, wherein the curve is formed at an end of the battery cell.

9. A battery cell, comprising:
a set of layers comprising a cathode with an active coating, a separator, and an anode with an active coating; and
a pouch enclosing the layers, wherein the pouch is flexible,
wherein a curve is formed in the battery cell by applying a pressure of at least 0.13 kilogram-force (kgf) per square millimeter to the layers using a set of curved plates.

10. The battery cell of claim 9, wherein the layers are wound to create a jelly roll.

11. The battery cell of claim 9, wherein the curve is further formed by applying a temperature of about 85° C. to the layers.

12. The battery cell of claim 11, wherein the layers further comprise a binder coating that laminates the layers together upon applying the pressure and the temperature to the layers.

13. The battery cell of claim 11, wherein the pressure and the temperature are applied to the layers for about four hours.

14. The battery cell of claim 9, wherein the curve is formed at an end of the battery cell.

15. The battery cell of claim 9, wherein the curve is formed to facilitate efficient use of space inside a portable electronic device.

16. A portable electronic device, comprising:
a set of components powered by a battery pack; and
the battery pack, comprising:
a battery cell, comprising:
a set of layers comprising a cathode with an active coating,
a separator, and an anode with an active coating; and
a pouch enclosing the layers, wherein the pouch is flexible,
wherein a curve is formed in the battery cell by applying a pressure of at least 0.13 kilogram-force (kgf) per square millimeter to the layers using a set of curved plates.

17. The portable electronic device of claim 16, wherein the layers are wound to create a jelly roll.

18. The portable electronic device of claim 16, wherein the curve is further formed by applying a temperature of about 85° C. to the layers.

19. The portable electronic device of claim 18, wherein the layers further comprise a binder coating that laminates the layers together upon applying the pressure and the temperature to the layers.

20. The portable electronic device of claim 18, wherein the pressure and the temperature are applied to the layers for about four hours.

21. The portable electronic device of claim 16, wherein the curve is formed at an end of the battery cell.

22. The portable electronic device of claim 16, wherein the curve is formed to facilitate efficient use of space inside the portable electronic device.
